(19) United States
(12) Patent Application Publication
(10) Pub. No.: US 2009/0047473 A1
(43) Pub. Date: Feb. 19, 2009

(54) NI-CONTAINING PLATING FILM AND METHOD OF MANUFACTURING THE SAME

(76) Inventors: Yoshihiro Kanada, Niigata-ken (JP); Shio Takahashi, Niigata-ken (JP); Koichi Fujita, Niigata-ken (JP); Mitsuhiro Gotoh, Niigata-ken (JP)

Correspondence Address: BRINKS HOFER GILSON & LIONE, P.O. BOX 10395, CHICAGO, IL, 60610, US

(21) Appl. No.: 12/187,886

(22) Filed: Aug. 7, 2008

(30) Foreign Application Priority Data
Aug. 14, 2007 (JP) 2007-211426

(51) Int. Cl. B32B 9/04; B32B 15/04; G11B 11/105; C25D 3/12

(52) U.S. Cl. 428/141; 428/698; 428/469; 428/332; 205/271

(57) ABSTRACT

A Ni-containing plating film includes a lower plating film and an upper plating film laminated on lower plating film. The lower plating film is formed by plating with no saccharin sodium added to a plating bath, and the upper plating film is formed by plating with saccharin sodium added to a plating bath. In the upper plating film, a NiS layer exists at a position below the film surface.

### CROSS REFERENCE TO RELATED APPLICATIONS

The present invention contains subject matter related to and claims priority to Japanese Patent Application JP 2007-211426 filed in the Japanese Patent Office on Aug. 14, 2007, the entire contents of which being incorporated herein by reference.

### BACKGROUND OF THE INVENTION

1. Field of the Invention

The present invention relates to a Ni-containing plating film that has a function to suppress spontaneous oxidation without deteriorating film characteristics, and a method of manufacturing the same.

2. Description of the Related Art

When a NiFe alloy is formed by plating, saccharin sodium is added to a plating bath as a brightener.

With this process, excellent brightness is achieved, but corrosion resistance is deteriorated. Furthermore, S (Sulfur) contained in saccharin sodium is taken into a plating film, and as a result, film characteristics, such as the saturation magnetic flux density Bs, are likely to be deteriorated.

### SUMMARY OF THE INVENTION

According to an embodiment, a Ni-containing plating film includes: a lower plating film; and an upper plating film laminated on lower plating film. The lower plating film is formed by plating with no saccharin sodium added to a plating bath, and the upper plating film is formed by plating with saccharin sodium added to a plating bath. In the upper plating film, a NiS layer exists at a position below the film surface.

The NiS layer functions to suppress spontaneous oxidation. The lower plating film is formed by plating with no saccharin sodium added to a plating bath, such that the amount of an impurity, such as S (Sulfur), taken into the film can be reduced. Therefore, according to the embodiment of the invention, it is possible to provide a Ni-containing plating film that has a function to suppress spontaneous oxidation without deteriorating film characteristics.

In an exemplary embodiment, at least a NiO₂ layer may exist on the film surface, and at least a NiSO layer may exist between the NiO₂ layer and the NiS layer.

### BRIEF DESCRIPTION OF THE DRAWINGS

FIG. 1 is a schematic view of a Ni-containing plating film according to a first embodiment of the invention;

FIG. 2 is a schematic view of a Ni-containing plating film according to a second embodiment of the invention;

FIG. 3 is a schematic view of a modification of the Ni-containing plating film shown in FIG. 2;

FIG. 4 is a schematic view of a Ni-containing plating film according to a third embodiment of the invention;

FIGS. 5A to 5C show an analysis result of a single-layer NiFe plating film which is formed by plating in a plating bath with saccharin sodium dihydrate added, and specifically, FIG. 5A shows a depth profile immediately after the film is formed by plating, FIG. 5B shows a depth profile 10 months later, and FIG. 5C shows a depth profile 16 months later;

FIG. 6A is a three-dimensional schematic view showing the states of individual components on the basis of the depth profile shown in FIG. 5A, FIG. 6B is a three-dimensional schematic view showing the states of individual components on the basis of the depth profile shown in FIG. 5B, and FIG. 6C is a three-dimensional schematic view showing the states of individual components on the basis of the depth profile shown in FIG. 5C;

FIGS. 7A to 7C show an analysis result of a single-layer NiFe plating film which is formed by plating in a plating bath with no saccharin sodium dihydrate added, and specifically, FIG. 7A shows a depth profile immediately after the film is formed by plating, FIG. 7B shows a depth profile 10 months later, and FIG. 7C shows a depth profile 16 months later;

FIG. 8A is a three-dimensional schematic view showing the states of individual components on the basis of the depth profile shown in FIG. 7A, FIG. 8B is a three-dimensional schematic view showing the states of individual components on the basis of the depth profile shown in FIG. 7B, and FIG. 8C is a three-dimensional schematic view showing the states of individual components on the basis of the depth profile shown in FIG. 7C;

FIGS. 9A to 9D show analysis results of Examples of laminates in which an upper NiFe plating film is laminated in a plating bath with no saccharin sodium dihydrate added on a lower NiFe plating, which is film formed by plating in a plating bath with saccharin sodium dihydrate added, while a plating time of the upper NiFe plating film is changed, and specifically, FIG. 9A is a three-dimensional schematic view showing the depth profile measured by using a time-of-flight secondary ion mass spectrometer and the states of individual components in Example 1, FIG. 9B is a three-dimensional schematic view showing the depth profile measured by a time-of-flight secondary ion mass spectrometer and the states of individual components in Example 2, FIG. 9C shows the depth profile measured by using a time-of-flight secondary ion mass spectrometer in Example 3, and FIG. 9D shows the depth profile measured by using a time-of-flight secondary ion mass spectrometer in Example 4;

FIG. 10 is a graph showing surface roughness Ra of respective Example in which an upper NiFe plating film is laminated in a plating bath with no saccharin sodium dihydrate added on a lower NiFe plating film, which is formed by plating in a plating bath with saccharin sodium dihydrate added, Comparative Example 1 in which a single-layer NiFe plating film is formed by plating in a plating bath with no saccharin sodium dihydrate added, and Comparative Example 2 in which a single-layer NiFe plating film is formed by plating in a plating bath with saccharin sodium dihydrate added;

FIG. 11 is a graph showing etching rates of respective Example in which an upper NiFe plating film is laminated in a plating bath with no saccharin sodium dihydrate added on a lower NiFe plating film, which is formed by plating in a plating bath with saccharin sodium dihydrate added, Comparative Example 1 in which a single-layer NiFe plating film is formed by plating in a plating bath with no saccharin sodium dihydrate added, and Comparative Example 2 in which a single-layer NiFe plating film is formed by plating in a plating bath with saccharin sodium dihydrate added;

FIG. 12A is a three-dimensional schematic view showing the depth profile and the states of individual components of a single-layer NiFe plating film which is formed by plating in a plating bath with about 0.05 g/l of saccharin sodium dihydrate added, FIG. 12B is a three-dimensional schematic view showing the depth profile and the states of individual components of a single-layer NiFe plating film which is formed by plating in a plating bath with about 0.1 g/l of saccharin sodium dihydrate added, and FIG. 12C is a three-dimensional schematic view showing the depth profile and the states of individual components of a single-layer NiFe plating film which is formed by plating in a plating bath with about 1.0 g/l of saccharin sodium dihydrate added;

FIG. 13 shows an analysis result when sputter ions to be used in time-of-flight secondary ion mass spectrometry (TOF-SIMS) are Cs⁺ (500 eV), Cs⁺ (2 keV), and Ar⁺ (500 eV);

FIG. 14 shows Ni (cal.) depth profiles by Auger electron spectroscopy (AES) of NiFe plating films, which are formed by plating in plating baths with the amount of saccharin sodium dihydrate changed;

FIG. 15 shows a depth profile before peak separation by Auger electron spectroscopy (AES), and depth profiles of Fe (cal.), Fe₂O₃ (cal.), Ni (orig.), Ni (cal.), NiO (cal.), S, and O after peak separation; and

FIG. 16 shows a Ni difference depth profile which is obtained by subtracting the Ni (cal.) depth profile of a NiFe plating film formed by plating in a plating bath with no saccharin sodium dihydrate added from the Ni (cal.) depth profile of each of NiFe plating films formed by plating in plating baths with the amount of saccharin sodium dihydrate changed.

### DESCRIPTION OF THE EMBODIMENTS

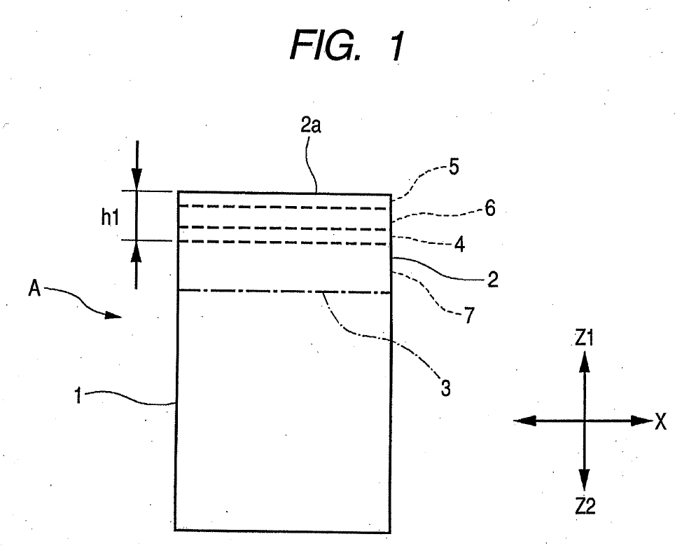

FIG. 1 is a schematic view of a Ni-containing plating film according to a first embodiment of the invention. In the drawing, the X direction denotes a width direction and the Z direction denotes a height direction (thickness direction).

A Ni-containing plating film A of the first embodiment is a laminate of, for example, a lower plating film 1 and an upper plating film 2, which are both made of NiFe. As a composition ratio, Fe is about 68% by mass and the content of Ni is about 32% by mass.

The lower plating film 1 is formed by plating with no saccharin sodium added to a plating bath, and the upper plating film 2 is formed by plating with saccharin sodium added to a plating bath.

A one-dot-chain line 3 shown in FIG. 1 represents an interface between the lower plating film 1 and the upper plating film 2, but the interface may be exposed to view or not. For example, if the lower plating film 1 and the upper plating film 2 are formed by plating with the same composition, the interface is not exposed to view. The position of the interface can be roughly discriminated on the basis of a depth profile by time-of-flight secondary ion mass spectrometry (TOF-SIMS).

As shown in FIG. 1, in the upper plating film 2, a NiS layer 4 exists at a position downward (in the drawing, Z2 direction) away from a film surface 2a. The “NiS layer” refers to a region where the amount of a NiS component is larger than those in other regions. Specifically, the NiS layer is defined as, on the basis of a depth profile by time-of-flight secondary ion mass spectrometry (TOF-SIMS), a region where a NiS/Ni strength ratio is 0.1 or more.

That is, although the NiS component exists not only in a film thickness region represented by reference numeral 4 but in other film thickness regions, a larger amount of NiS component exists in the film thickness region represented by reference numeral 4.

As shown in FIG. 1, at least a NiO₂ layer 5 exists on the film surface 2a, and at least NiSO layer 6 exists between the NiO₂ layer 5 and the NiS layer 4. The “NiO₂ layer” and “NiSO layer” are defined as, on the basis of a depth profile by means of time-of-flight secondary ion mass spectrometry (TOF-SIMS), a region where a NiO₂/Ni strength ratio is 0.7 or more and a region where a NiSO/Ni strength ratio is 0.1 or more, respectively. The NiO₂ layer 5 or the NiSO layer 6 may exist at the same position as the NiS layer 4. For example, in the region represented by reference numeral 4, the amount of NiS component is larger than those in other regions, and in a region including the regions represented by reference numerals 4 and 6, the amount of NiSO component is larger than those in other regions.

At least a Ni layer 7 exists below the NiS layer 4. Actually, the Ni layer 7 exists over the lower plating film 1 and the upper plating film 2.

As such, Ni exists in the plating film A in various states. What state Ni including S taken into the plating film A in minute amount and O exists in the plating film A can be analyzed on the basis of the depth profile by time-of-flight secondary ion mass spectrometry (TOF-SIMS). During the time-of-flight secondary ion mass spectrometry (TOF-SIMS), secondary ions having different masses, such as fragment ions or molecular ions, are discharged. In this case, by predicting the existence of a NiS component, a NiSO component, a NiO₂ component, and a Ni element component, and by inputting the respective masses to the spectrometer, it is possible to obtain the depth profiles of the NiS component, the NiSO component, a NiO₂ component, and the Ni element component. If analysis is performed by using Auger electron spectroscopy (AES) together with the time-of-flight secondary ion mass spectrometry (TOF-SIMS), the existence of the NiS layer 4 and the NiSO layer 6 near the film surface can be accurately analyzed, and in particular, quantitative analysis can be performed.

The NiS layer 4 has a function to suppress spontaneous oxidation. The NiS layer 4 preferably exists within 10 nm downward (in the drawing, Z1 direction) from the film surface 2a (h1 shown in FIG. 1 is within 10 nm). Therefore, it is possible to suppress spontaneous oxidation near the film surface 2a of the plating film A, and to prevent film characteristics from being deteriorated. While the plating film is formed, oxygen contained in the NiO₂ layer 5 and the NiSO layer 6 on the NiS layer 4 is taken into the film. Oxygen taken into the film while the plating film is formed also exists in a region below the NiS layer 4. However, from a temporal change in an experiment described below, it can be seen that the NiS layer 4 mostly stops entrance of oxygen due to spontaneous oxidation, thereby suppressing spontaneous oxidation.

The thickness of each of the NiS layer 4, the NiO₂ layer 5, and the NiSO layer 6 is in a range of approximately 1 nm to 3 nm. The thickness of the entire plating film A is in a range of approximately 0.6 to 5.6 μm, the thickness of the lower plating film 1 is in a range of approximately 0.3 to 2.8 μm, and the thickness of the upper plating film 2 is in a range of approximately 0.3 to 2.8 μm.

In the first embodiment, the upper plating film 2 including the NiS layer 4 is formed by plating with no saccharin sodium added to a plating bath. The upper plating film 2 can be used as a protective film against the lower plating film 1 containing a small amount of impurity component, such as S (Sulfur). As such, the amount of the impurity component taken into the lower plating film 1 can be reduced. Therefore, the film characteristics of the lower plating film 1, for example, a saturation magnetic flux density Bs can be increased. Meanwhile, if the upper plating film 2 that is likely to contain an impurity component more than the lower plating film 1 is slightly thicker, the film characteristics of the entire plating film A may be more significantly deteriorated than the film characteristics of the lower plating film 1 only. Therefore, the upper plating film 2 is formed to be thin so as not to obstruct the formation of the NiS layer 4. For example, at least the upper plating film 2 is formed to have a smaller thickness than the lower plating film 1. Alternatively, the upper plating film 2 may be formed to have such a minimum thickness that the NiS layer 4 exists (that is, such a thickness that the NiS layer 4 becomes a lowermost layer in the upper plating film 2). In this case, the upper plating film 2 can be further effectively formed to be thin.

In this way, the plating film A that can effectively suppress spontaneous oxidation while preventing the film characteristics of the lower plating film 1 from being deteriorated can be provided.

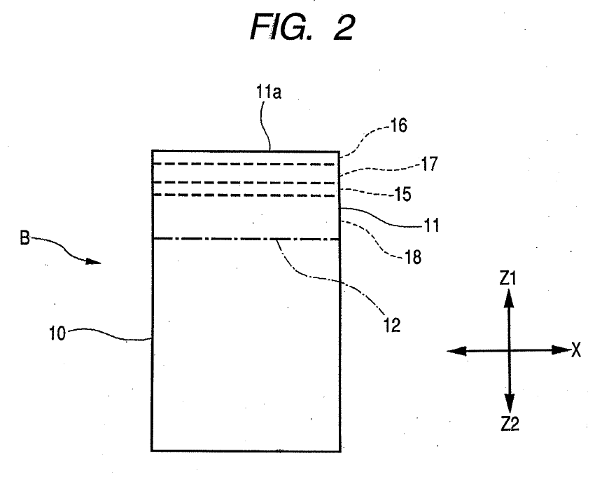

FIG. 2 is a schematic view of a Ni-containing plating film according to a second embodiment of the invention. In the drawing, the X direction denotes a width direction and the Z direction denotes a height direction (thickness direction).

A Ni-containing plating film B of the second embodiment is a laminate of, for example, a lower plating film 10 and an upper plating film 11, which are both made of NiFe.

The lower plating film 10 is formed by plating with saccharin sodium added to a plating bath, and the upper plating film 11 is formed by plating with no saccharin sodium added to a plating bath. That is, the plating film B of the second embodiment has a reverse laminate structure, as compared with the plating film A of the first embodiment shown in FIG. 1.

A one-dot-chain line 12 shown in FIG. 2 represents an interface between the lower plating film 10 and the upper plating film 11, but the interface may be exposed to view or not. This is as described with reference to FIG. 1.

As shown in FIG. 2, in the upper plating film 11, a NiS layer 15 exists at a position (in the drawing, Z2 direction) downward away from a film surface 11a. Further, as shown in FIG. 2, at least a NiO₂ layer 16 exists on the film surface 11a, and at least a NiSO layer 17 exists between the NiO₂ layer 16 and the NiS layer 15. At least a Ni layer 18 exists below the NiS layer 15. The NiS layer 15, the NiO₂ layer 16, the NiSO layer 17, and the Ni layer 18 exist in the same state as described with reference to FIG. 1.

In the second embodiment, the upper plating film 11 is formed by plating with no saccharin sodium added to a plating bath. Nonetheless, the NiS layer 15 exists in the upper plating film 11. It is supposed that the NiS layer near the surface of the lower plating film 10, which is formed by plating with saccharin sodium added to a plating bath, moves into the upper plating film 11 during plating growth of the upper plating film 11. In an experiment described below, it is confirmed that the NiS layer 15 exists in the upper plating film 11.

According to the second embodiment shown in FIG. 2, similarly to the first embodiment shown in FIG. 1, the plating film B that can effectively suppress spontaneous oxidation can be provided. In addition, the surface roughness Ra of the plating film B can be suppressed to be 40 Å or less, and excellent smoothness can be achieved as compared with a single-layer structure of the upper plating film 11 which is formed by plating with no saccharin sodium added to a plating bath. Furthermore, excellent corrosion resistance can be achieved as compared with a single-layer structure of the upper plating film 11 with no saccharin sodium added to a plating bath and a single-layer structure of the lower plating film 10 with saccharin sodium added to a plating bath. Furthermore, a comparatively good glossy surface can be provided.

The thickness of the upper plating film 11 shown in FIG. 2 is in a range of approximately 0.3 to 1.4 μm, and the thickness of the lower plating film 10 is in a range of approximately 0.3 to 2.8 μm.

As the upper plating film 11 is thickened, the region of the NiS layer 15 is gradually decreased. Then, NiS spreads over the film and the NiS layer 15 does not exist longer (see FIG. 3). In this case, the surface roughness Ra of the film surface 1a can be suppressed to be about 40 Å or less, and excellent smoothness can be achieved as compared with a single-layer structure of the upper plating film 11 which is formed by plating with no saccharin sodium added to a plating bath. In addition, excellent corrosion resistance can be achieved as compared with a single-layer structure of the upper plating film 11, which is formed by plating with no saccharin sodium added to a plating bath, and a single-layer structure of the lower plating film 10, which is formed by plating with saccharin sodium added to a plating bath. Furthermore, a comparatively good glossy surface can be provided. As shown in FIG. 3, if the upper plating film 11 is thickened and the NiS layer 15 becomes extinct, the film characteristics inherent in the upper plating film 11 can be prevented from being deteriorated. The upper plating film 11 is formed by plating with no saccharin sodium added to a plating bath. Accordingly, the upper plating film 11 inherently has a high saturation magnetic flux density Bs. Alternatively, even if the upper plating film 11 is formed by plating on the lower plating film 10, which is formed by plating with saccharin sodium added to a plating bath, the film characteristics of the upper plating film 11 can be prevented from being deteriorated.

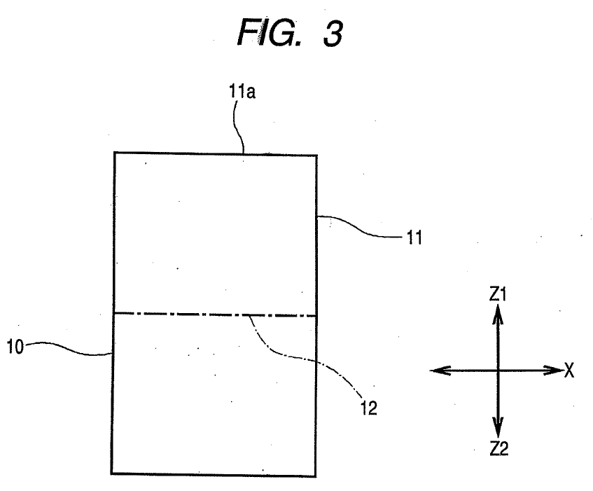

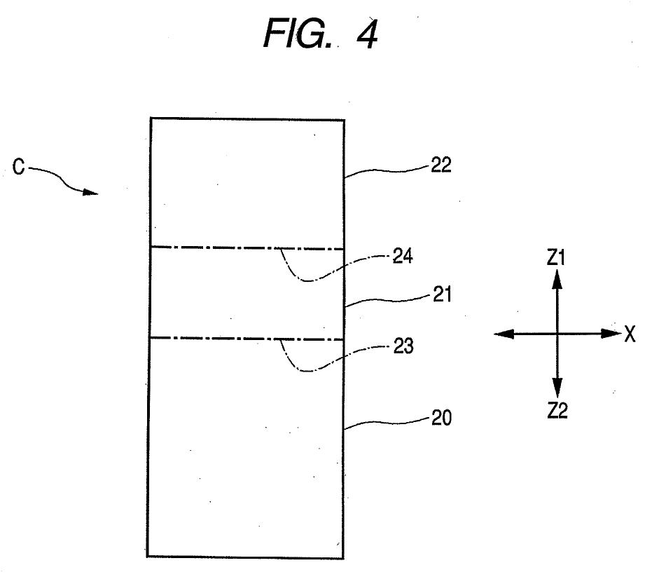

FIG. 4 is a schematic view of a Ni-containing plating film according to a third embodiment of the invention. In the drawing, the X direction denotes a width direction and the Z direction denotes a height direction (thickness direction).

A Ni-containing plating film C of the third embodiment is a laminate of, for example, a lower plating film 20 and an upper plating film 22, which are both made of NiFe, and an intermediate film 21 interposed between the lower plating film 20 and the upper plating film 22.

The lower plating film 20 is formed by plating with saccharin sodium added to a plating bath, and the upper plating film 22 is formed by plating with no saccharin sodium added to a plating bath.

One-dot-chain lines 23 and 24 shown in FIG. 3 represent an interface between the lower plating film 20 and the intermediate film 21 and an interface between the intermediate film 21 and the upper plating film 22, respectively, but the interfaces may be exposed to view or not. This is as described with reference to FIG. 1. The intermediate film 21 is provided so as not to move a NiS layer formed in the lower plating film 20 toward the upper plating film 22.

In the third embodiment, unlike the embodiment shown in FIG. 1 or 2, no NiS layer exists in the plating film C.

As described with reference to FIG. 3, if the upper plating film 11 formed by plating with no saccharin sodium added to a plating bath on the lower plating film 10 formed by plating with saccharin sodium added to a plating bath is thickened, a NiS layer becomes extinct. Referring to FIG. 4, the intermediate film 21 is provided between the lower plating film 20 formed by plating with saccharin sodium added to a plating bath and the upper plating film 22 formed by plating with no saccharin sodium added to a plating bath. The intermediate film 21 is provided so as not to move the NiS layer, which is formed to have a predetermined thickness or more, toward the upper plating film 22. Then, even if the upper plating film 22 is formed to have the same thickness as the upper plating film 11 shown in FIG. 2, the movement of the NiS layer toward the upper plating film 22 is blocked. In this embodiment, no NiS layer exists.

When the intermediate film 21 is formed by plating, no saccharin sodium is added to a plating bath.

In the third embodiment, as for the intermediate film 21, any material may be used. For example, the intermediate film 21 may be made of a material not containing Ni. The intermediate film 21 may be made of only elements other than magnetic elements, such as Ni, Co, and Fe.

The intermediate film 21 may be made of the same material as the lower plating film 20 and the upper plating film 22, for example, NiFe. If the intermediate film 21 and the lower and upper plating film 20 and 22 have the same composition ratio, the laminate has the same shape as shown in FIG. 3. Therefore, in order to form at least the intermediate film 21 with a composition ratio different from those of the lower plating film 20 and the upper plating film 22, the laminate shown in FIG. 4 can be used. By adjusting the total thickness of the intermediate film 21 and the upper plating film 22 to be equal to the thickness of the upper plating film 11 shown in FIG. 3, the NiS layer can become extinct.

As shown in FIG. 4, when the intermediate film 21 is provided between the lower plating film 20 and the upper plating film 22, it is possible to realize a laminate including the lower plating film 20 and the upper plating film 22, without deteriorating the film characteristics of the upper plating film 22, which is formed by plating with no saccharin sodium added to a plating bath.

If the NiS layer does not exist in the upper plating film 22, it may exist in the lower plating film 20 or the intermediate film 21.

A method of manufacturing the plating film A of the first embodiment will be described. The plating film A is formed by plating, for example, through an electroplating method. In order to form a NiFe alloy by plating through the electroplating method, Fe ions and Ni ions are contained in a plating bath.

When the lower plating film 1 is formed by plating, no saccharin sodium is added to a plating bath. For example, to the plating bath, FeSO₄.7H₂O, NiSO₄.6H₂O, H₃BO₃, NaCl, and C₁₂H₂₅NaO₄S are added.

In the electroplating method, a plating film is formed by plating using a pulse current or a DC current. A current density is, for example, approximately 6.4 mA/cm² (average).

After the lower plating film 1 is formed by plating, the upper plating film 2 is formed by plating on the lower plating film 1. When the upper plating film 2 is formed by plating, saccharin sodium dihydrate is added to a plating bath. The amount of saccharin sodium dihydrate in the plating bath is in a range of about 0.05 g/l to about 2.0 g/l. More preferably, the amount of saccharin sodium dihydrate is in a range of about 0.1 g/l to about 1.0 g/l. Even if the amount of saccharin sodium is set to be small, the NiS layer 4 can be formed in the upper plating film 2. In addition, if the amount of saccharin sodium is set to be small, the amount of an impurity, such as S (sulfur), taken into the upper plating film 2 can be reduced. Saccharin sodium is added to the plating bath as C₇H₄NO₃S.Na.2H₂O.

Additives to the plating bath for the upper plating film 2 are the same as additives to the plating bath for the lower plating film 1, other than saccharin sodium. In addition, the current density when the upper plating film 2 is formed by plating is set to be equal to the current density when the lower plating film 1 is formed by plating.

If the upper plating film 2 is formed by plating, as shown in FIG. 1, the NiS layer 4 is formed in the upper plating film 2 at a position downward (in the drawing, Z2 direction) away from the film surface 2a. In addition, oxygen is taken into a region between the film surface 2a and the NiS layer 4 while the plating film is formed, and the NiO₂ layer 5 or the NiSO layer 6 is formed.

The NiS layer 4 is formed in the upper plating film 2 and the upper plating film 2 is used as a protective film for the lower plating film 1. In this case, if the upper plating film 2 is excessively thickened, the film characteristics of the plating film A may be deteriorated. In addition, if the upper plating film 2 is excessively thinned, the NiS layer 4 may not be appropriately formed in the upper plating film 2. Therefore, on the basis of the analysis result by means of time-of-flight secondary ion mass spectrometry (TOF-SIMS), the upper plating film 2 is preferably formed by plating to have such a thickness that the NiS layer 4 exists in the upper plating film 2. At this time, the upper plating film 2 is preferably formed to have such a small thickness such that the NiS layer 4 becomes a lowermost layer in the upper plating film 2.

Next, a method of manufacturing the plating film B of the second embodiment will be described. The plating film B is formed by plating, for example, through an electroplating method. In order to form a NiFe alloy by plating, Fe ions and Ni ions are contained in a plating bath which is used in the electroplating method.

When the lower plating film 10 is formed by plating, saccharin sodium is added to a plating bath. The amount of saccharin sodium dihydrate in the plating bath is in a range of about 0.05 g/l to about 2.0 g/l. More preferably, the amount of saccharin sodium dihydrate is in a range of about 0.1 g/l to about 1.0 g/l. For example, to the plating bath, FeSO₄.7H₂O, NiSO₄.6H₂O, C₇H₄NO₃S.Na.2H₂O, H₃BO₃, NaCl, and C₁₂H₂₅NaO₄S are added.

In the electroplating method, a plating film is formed by plating using a pulse current or a DC current. A current density is, for example, approximately 6.4 mA/cm² (average).

After the lower plating film 10 is formed by plating, the upper plating film 11 is formed by plating on the lower plating film 10. When the upper plating film 11 is formed by plating, no saccharin sodium is added to a plating bath. Additives to the plating bath for the upper plating film 11 are the same as additives to the plating bath for the lower plating film 10, other than saccharin sodium. In addition, the current density when the upper plating film 11 is formed by plating is set to be equal to the current density when the lower plating film 10 is formed by plating.

As shown in FIG. 2, the upper plating film 11 is formed by plating to have such a thickness that the NiS layer in the lower plating film 10 moves into the upper plating film with plating growth of the upper plating film. Alternatively, as shown in FIG. 3, the upper plating film 11 is formed by plating to have such a thickness that the NiS layer in the lower plating film 10 becomes extinct with plating growth of the upper plating film.

The thickness of the upper plating film 11 is preferably adjusted on the basis of the analysis result by means of time-of-flight secondary ion mass spectrometry (TOF-SIMS).

In the second embodiment, by adjusting the amount of saccharin sodium in the plating bath for the lower plating film 10, the Ni-containing plating film B having small surface roughness and excellent corrosion resistance can be simply and appropriately manufactured. In addition, comparatively good brightness of the film surface can be achieved. Furthermore, if the amount of saccharin sodium is reduced as small as possible within the above range, the amount of an impurity, such as S (Sulfur), taken into the lower plating film 10 can be reduced, and film characteristics can be prevented from being deteriorated.

Next, a method of manufacturing the plating film C of the third embodiment will be described. The plating film C is formed by plating, for example, through an electroplating method. In order to form a NiFe alloy by plating, Fe ions and Ni ions are contained in a plating bath which is used in the electroplating method.

When the lower plating film 20 is formed by plating, saccharin sodium is added to a plating bath. The amount of saccharin sodium dihydrate in the plating bath is in a range of about 0.05 g/l to about 2.0 g/l. More preferably, the amount of saccharin sodium dihydrate is in a range of about 0.1 g/l to about 1.0 g/l. For example, to the plating bath, FeSO₄.7H₂O, NiSO₄.6H₂O, C₇H₄NO₃S.Na.2H₂O, H₃BO₃, NaCl, and C₁₂H₂₅NaO₄S are added.

In the electroplating method, a plating film is formed by plating using a pulse current or a DC current. A current density is, for example, approximately 6.4 mA/cm² (average).

After the lower plating film 20 is formed by plating, the intermediate film 21 is formed by plating on the lower plating film 20. When the intermediate film 21 is formed by plating, no saccharin sodium is added to a plating bath. For example, the intermediate film 21 is made of a material different from the material for the lower plating film 20. The intermediate film 21 is provided to cause the NiS layer in the lower plating film 20 to be extinct. Therefore, the thickness of the intermediate film 21 is preferably adjusted on the basis of the analysis result by means of time-of-flight secondary ion mass spectrometry (TOF-SIMS).

Subsequently, the upper plating film 22 is formed by plating on the intermediate film 21. When the upper plating film 22 is formed by plating, no saccharin sodium is added to a plating bath. For example, additives to the plating bath to the upper plating film 22 are the same as additives to the plating bath for the lower plating film 20, other than saccharin sodium. In addition, a current density when the upper plating film 22 is formed by plating is set to be equal to a current density when the lower plating film 20 is formed by plating.

In the third embodiment, no NiS layer exists in the plating film C. Therefore, it is possible to obtain a laminate including the lower plating film 20 and the upper plating film 22, without deteriorating the film characteristics of the upper plating film 22, which is formed by plating with no saccharin sodium added to the plating bath.

The amount of saccharin sodium depends on the analysis result by means of time-of-flight secondary ion mass spectrometry (TOF-SIMS).

On the basis of an analysis result by means of Auger electron spectroscopy (AES), or both the analysis result by means of time-of-flight secondary ion mass spectrometry (TOF-SIMS) and the analysis result by means of Auger electron spectroscopy (AES), the thickness of the upper plating film or the intermediate film, or the amount of saccharin sodium may be adjusted.

An analysis method (management method) of the plating film will be described.

For example, after the plating film A of the first embodiment shown in FIG. 1 is formed by plating, analysis is performed by using time-of-flight secondary ion mass spectrometry (TOF-SIMS). For the time-of-flight secondary ion mass spectrometry (TOF-SIMS), for example, TOF-SIMS V manufactured by ION TOF is used.

For example, negatively charged secondary ions are detected by using Bi⁺ (1 pA, 25 keV) as an excited ion beam and Cs⁺ (500 eV) as sputter ions.

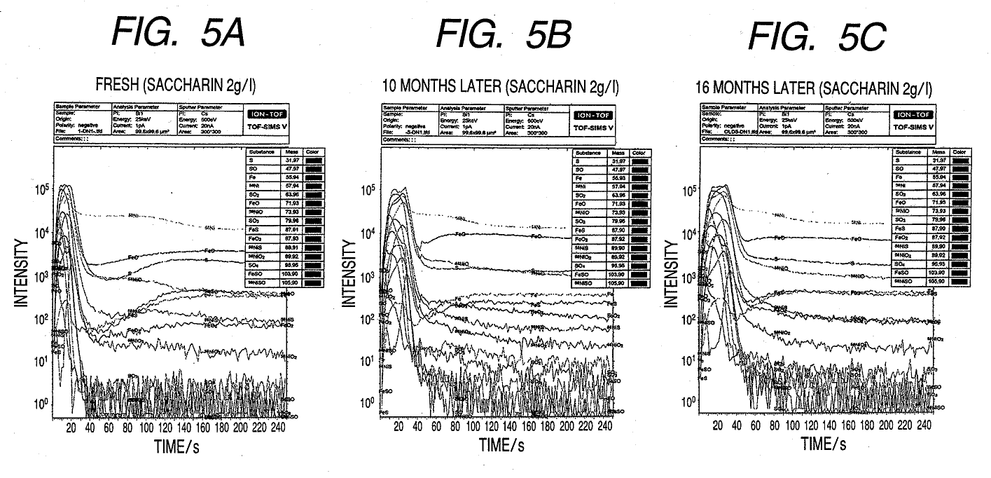

For example, the depth profiles of individual components shown in FIG. 5A are obtained. FIGS. 5A to 5C show the depth profile of a single-layer NiFe plating film which is formed by plating with saccharin sodium added to a plating bath, as described below. At this point of time, each depth profile does not specify what component data corresponds to.

Therefore, by considering a chemical reaction with the additives in the plating bath, the mass of a component, which is expected to be contained in the NiFe plating film is input to the spectrometer (mass), and then the component of each depth profile shown in FIG. 5A is specified.

As shown in FIG. 5A, it can be seen that the strength of a NiS component or a NiSO component according to the depth profile is larger on the film surface than inside of the film. In addition, the NiS component or the NiSO component is biased toward the film surface.

As described above, for the time-of-flight secondary ion mass spectrometry (TOF-SIMS), Cs⁺ is preferably used as the sputter ions. From an experiment result described below, it can be seen that, if Ar⁺ is used as the sputter ions, the NiS component may be dissolved and the NiS component may not be detected.

During the time-of-flight secondary ion mass spectrometry (TOF-SIMS), quantitative analysis cannot be performed. For this reason, only with the analysis result by means of the time-of-flight secondary ion mass spectrometry (TOF-SIMS), it is unclear how much the NiS component or the NiSO component exists near the film surface. To clear that a large amount of NiS component or NiSO component exists near the film surface, additional analysis is performed by using Auger electron spectroscopy (AES). As an Auger electron spectrometer, for example, JAMP-7830F. manufactured by JEOL Ltd. may be used.

As for the measurement conditions, for example, an electron beam of 5 keV and 10 nA, and Ar⁺ (500 eV) is used as the sputter ions.

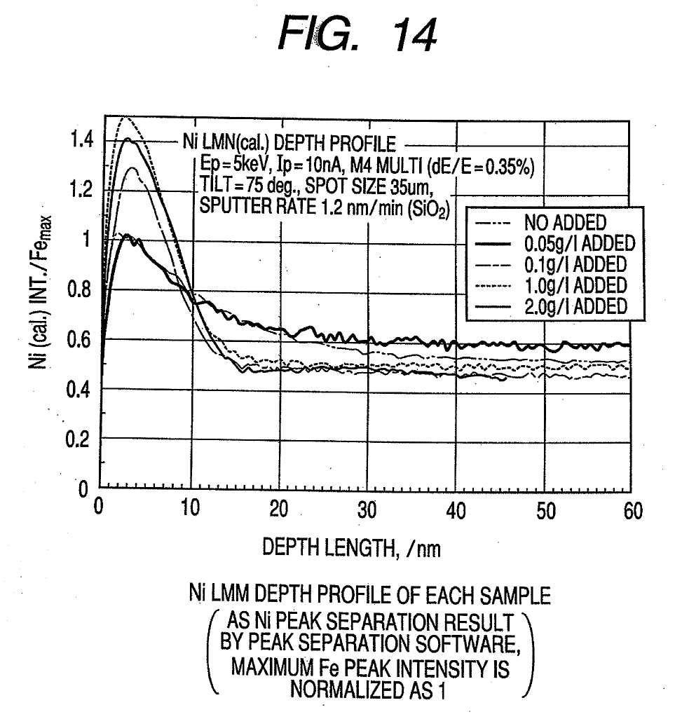

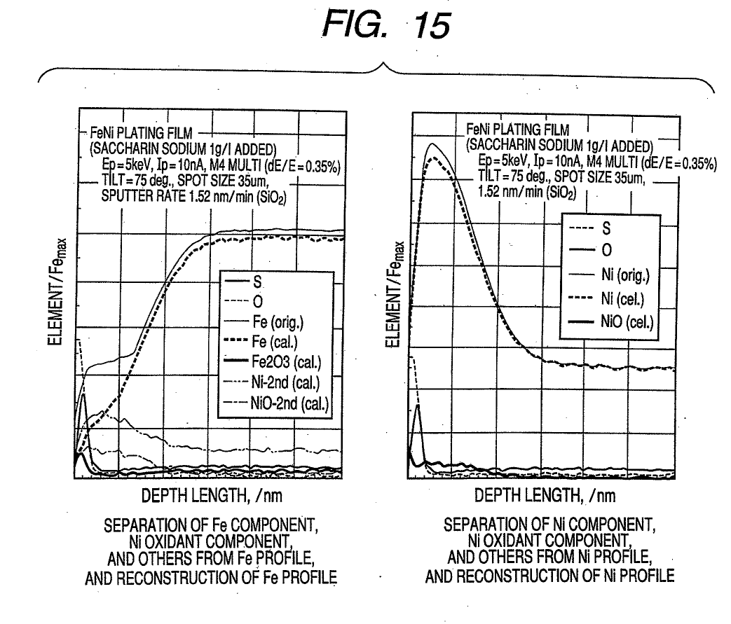

In the Auger electron spectroscopy (AES), a depth profile shown in FIG. 14 is obtained, for example. FIG. 14 shows Ni (cal.) depth profiles of single-layer NiFe plating films, which are formed by plating with the amount of saccharin sodium in a plating bath changed, as described below. Ni exists in the plating film as an element component, a NiO component, a NiS component, and a NiSO component. FIG. 15 shows a Ni (orig.) depth profile which synthesizes the element component, the NiO component, the NiS component, and the NiSO component. In the Auger electron spectroscopy (AES), it is difficult to individually separate the NiS component and the NiSO component among the components. Meanwhile, since the NiO component can be separated, as shown in FIG. 15, a Ni (cal.) depth profile is obtained by separating a NiO (cal.) depth profile from the Ni (orig.) depth profile. This Ni (cal.) depth profile synthesizes the element component, the NiS component, and the NiSO component.

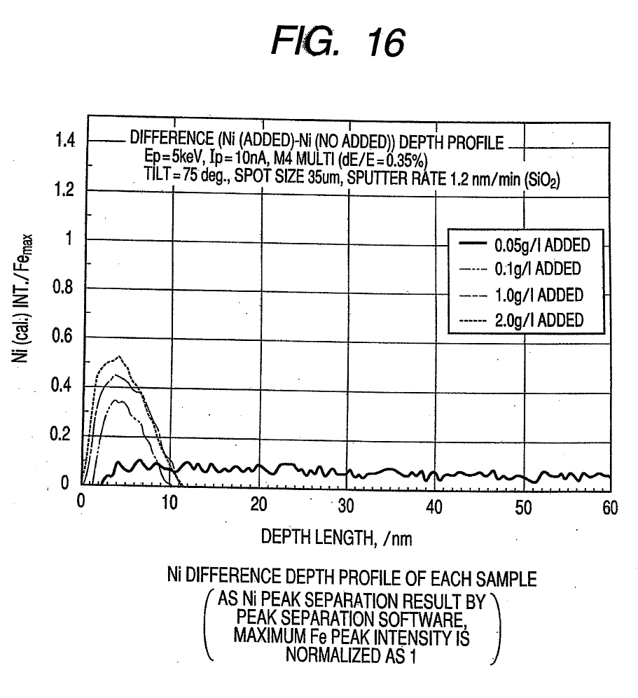

As shown in FIG. 14, the Ni (cal.) depth profile of a NiFe alloy formed by plating with no saccharin sodium added to a plating bath is first obtained. Thereafter, the Ni (cal.) depth profile of the NiFe alloy formed by plating with no saccharin sodium added to the plating bath is subtracted from the Ni (cal.) depth profile of a NiFe alloy formed by plating with saccharin sodium added to a plating bath. Then, a Ni depth profile of a substantially element component is come off. Thus, a Ni difference depth profile shown in FIG. 16 is obtained. As shown in FIG. 16, if about 0.1 g/l to about 2.0 g/l of saccharin sodium dihydrate is added, a Ni (cal.) difference is obtained near the film surface. Therefore, the reason why the Ni (cal.) difference is obtained near the film surface is that the NiSO component or the NiS component exists near the film surface. From this, it can be confirmed that the result coincides with the experiment result of the time-of-flight secondary ion mass spectrometry (TOF-SIMS).

In the Auger electron spectroscopy (AES), as shown in FIG. 16, a Ni difference depending on the amount of saccharin sodium and a depth position of the Ni difference are obtained. Therefore, on the basis of this data or synthesis data of the Auger electron spectroscopy (AES) and the time-of-flight secondary ion mass spectrometry (TOF-SIMS), the amount of saccharin sodium in the plating bath or adjustment of a plating thickness can be appropriately managed.

In the embodiments, the purposes of the plating films A, B, and C are not particularly limited. The plating film of each embodiment may be used for a metal film of an electronic part or the like. The metal film may be magnetic or nonmagnetic. In addition, if the plating film of each embodiment is used in an electrical contact, spontaneous oxidation of the electrical contact can be effectively suppressed, and an electrical contact having excellent corrosion resistance and smoothness can be provided. Furthermore, the plating film of the invention can be used in a part of an elastic member. Since a noncrystalline structure of NiP exhibits elasticity, if each embodiment is applied, an elastic member which has a function to suppress spontaneous oxidation and exhibits excellent corrosion resistance and smoothness can be formed.

### EXAMPLES

### Depth Profile by Means of Time-of-Flight Secondary Ion Mass Spectrometry (TOF-SIMS); Single-Layer NiFe Plating Film

A single-layer NiFe alloy film was formed by plating in the following plating bath.

(Plating Bath Composition)

FeSO₄.7H₂O 25 (g/l)

NiSO₄.6H₂O 190 (g/l)

H₃BO₃ 25 (g/l)

C₇H₄NO₃S.Na.2H₂O 2 (g/l)

NaCl 25 g/l

C₁₂H₂₅NaO₄S 0.02 g/l

(Bath Condition)

Bath Temperature 30° C.

pH 2.7

Current Density (average) 6.4 mA/cm²

As described above, after single-layer NiFe plating film was formed by using a plating bath with saccharin sodium dihydrate added, analysis was performed by means of the time-of-flight secondary ion mass spectrometry (TOF-SIMS). As the time-of-flight secondary ion mass spectrometer, TOF-SIMS V manufactured by ION TOF was used.

The negatively charged secondary ions were detected by using Bi⁺ (1 pA, 25 keV) as an excited ion beam and Cs⁺ (500 eV) as sputter ions.

The depth profile of FIG. 5A is the measurement result immediately after the plating film is formed, the depth profile of FIG. 5B is the measurement result 10 months later, and the depth profile of FIG. 5C is the measurement result 16 months later.

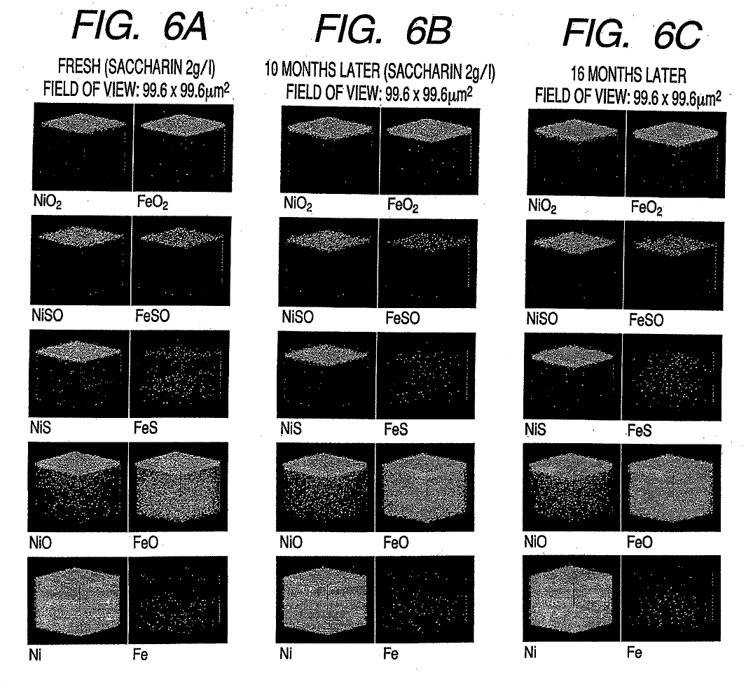

FIG. 6A is a three-dimensional schematic view showing the states of individual components on the basis of the depth profile of FIG. 5A. FIG. 6A shows that a large amount of component exists in a bright portion. FIG. 6B is a three-dimensional schematic view showing the states of individual components on the basis of the depth profile of FIG. 5B. FIG. 6C is a three-dimensional schematic view showing the states of individual components on the basis of the depth profile of FIG. 5C.

As shown in FIGS. 5A and 6A, it could be seen that a large amount of NiS component existed near the film surface. It could be seen that the NiS component concentrated within approximately 3 nm in a film depth direction from the film surface. In addition, it could be seen that a large amount of NiO₂ component or NiSO component existed on the film surface. A depth region where the strength ratio of each component in the depth profile by time-of-flight secondary ion mass spectrometry (TOF-SIMS) satisfies the conditions NiS/Ni strength ratio: 0.1 or more, NiO₂/Ni strength ratio: 0.7 or more, and NiSO/Ni strength ratio: 0.1 or more is defined as “layer”. Then, in the single-layer NiFe plating film formed by plating with saccharin sodium dihydrate added to the plating bath, it could be seen that a NiS layer existed downward the film surface, at least a NiO₂ layer exists on the film surface, a NiSO layer exists between the NiS layer and the NiO₂ layer, and a Ni layer exists below the NiS layer.

As seen from the temporal change shown in FIGS. 5B and 5C, and FIGS. 6B and 6C, it could be seen that spontaneous oxidation did almost not proceed. It is supposed that spontaneous oxidation is suppressed by the NiS layer existing near the film surface. Referring to FIGS. 5A and 6A, in the measurement result immediately after the plating film is formed, oxygen in the NiO component, the NiSO component, and the FeO component is taken while the plating film is formed.

Next, a single-layer NiFe plating film was formed by plating in the following plating bath.

### Plating Bath Composition)

FeSO₄.7H₂O 25 (g/l)

NiSO₄.6H₂O 190 (g/l

H₃BO₃ 25 (g/l)

NaCl 25 g/l

C₁₂H₂₅NaO₄S 0.02 g/l

### (Bath Condition)

Bath Temperature 30° C.

pH 2.7

Current Density (average) 6.4 mA/cm²

As described above, after a single-layer NiFe plating film was formed by plating in a plating bath with no saccharin sodium added, and analysis was performed by means of time-of-flight secondary ion mass spectrometry (TOF-SIMS). For the time-of-flight secondary ion mass spectrometry (TOF-SIMS), TOF-SIMS V manufactured by ION TOF was used.

The negatively charge secondary ions were detected by using Bi⁺ (1 pA, 25 keV) as an excited ion beam, and Cs⁺ (500 eV) as sputter ions.

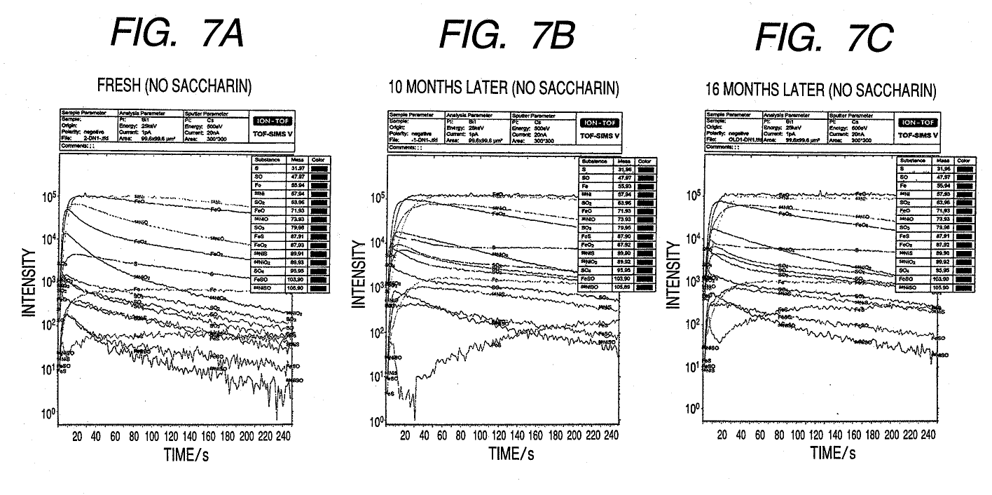

A depth profile of FIG. 7A is the measurement result immediately after the plating film is formed, a depth profile of FIG. 7B is the measurement result 10 months later, and a depth profile of FIG. 7C is the measurement result 16 months later.

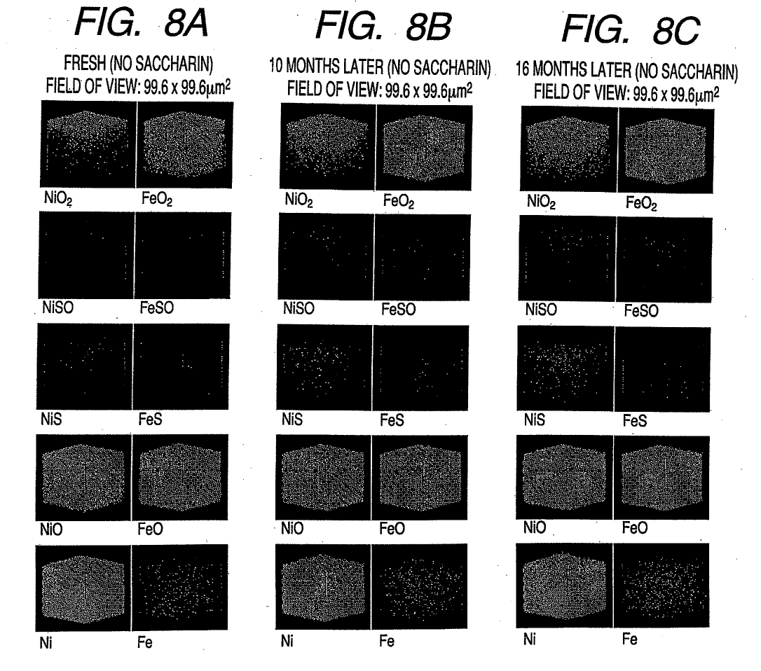

FIG. 8A is a three-dimensional schematic view showing the states of individual components on the basis of the depth profile of FIG. 7A. FIG. 8B is a three-dimensional schematic view showing the states of individual components on the basis of the depth profile of FIG. 7B. FIG. 8C is a three-dimensional schematic view showing the states of individual components on the basis of the depth profile of FIG. 7C.

In the single-layer NiFe plating film formed by plating in a plating bath with no saccharin sodium added, as shown in FIGS. 7A and 8A, oxygen is taken into the entire film immediately after the film is formed. This may be because, as well as oxygen taken into the plating film while the film is formed, spontaneous oxidation starts immediately after the film is formed, and then oxygen proceeds into the film deeply. From the temporal change shown in FIGS. 7B and 7C and FIGS. 8B and 8C, it could be seen that oxygen was further taken into the film.

[Depth Profile by Means of Time-of-Flight Secondary Ion Mass Spectrometry (TOF-SIMS); Laminated NiFe Plating Film]

Next, a lower NiFe plating film was formed by plating in the following plating bath.

(Plating Bath Composition)

FeSO₄.7H₂O 25 (g/l)

NiSO₄.6H₂O 190 (g/l)

C₇H₄NO₃S.Na.2H₂O 1 (g/l)

H₃BO₃ 25 (g/l)

C₇H₄NO₃S.Na.2H₂O 2 (g/l)

NaCl 25 g/l

C₁₂H₂₅NaO₄S 0.02 g/l

### (Bath Condition)

Bath Temperature 30° C.

pH 2.7

Current Density (average) 6.4 mA/cm²

In this way, the lower NiFe plating film was formed by plating in a plating bath with saccharin sodium dihydrate added.

Next, an upper NiFe plating film was formed by plating on the lower NiFe plating film by means of the following plating bath.

(Plating Bath Composition)

FeSO₄.7H₂O 25 (g/l)

NiSO₄.6H₂O 190 (g/l)

H₃BO₃ 25 (g/l)

NaCl 25 g/l

C₁₂H₂₅NaO₄S 0.02 g/l

### (Bath Condition)

Bath Temperature 30° C.

pH 2.7

Current Density (average) 6.4 mA/cm²

In this way, the upper NiFe plating film was formed by plating in a plating bath with no saccharin sodium added.

In the experiment, the plating time of the upper NiFe plating film was set to be 10 seconds (Example 1), 30 seconds (Example 2), 60 seconds (Example 3), and 120 seconds (Example 4). Then, upper plating films having different thicknesses were formed by plating on the lower plating film. The thickness of the upper NiFe plating film formed by plating for 10 seconds was approximately 27.5 nm, and the thickness of the upper NiFe plating film formed by plating for 30 seconds was approximately 72 nm. In addition, the thickness of the upper NiFe plating film formed by plating for 60 seconds was approximately 140 nm, and the thickness of the upper NiFe plating film formed by plating for 120 seconds was approximately 280 nm.

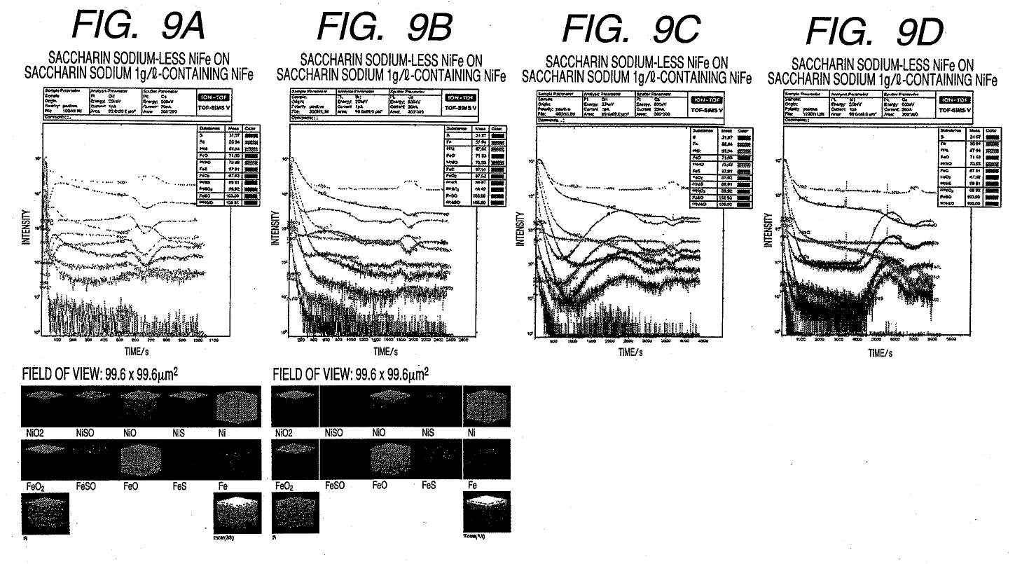

FIG. 9A is a three-dimensional schematic view showing a depth profile measured by using the time-of-flight secondary ion mass spectrometer and the states of individual components in Example 1. FIG. 9B is a three-dimensional schematic view showing a depth profile measured by using the time-of-flight secondary ion mass spectrometer and the states of individual components in Example 2. FIG. 9C shows a depth profile measured by using the time-of-flight secondary ion mass spectrometer in Example 3. FIG. 9D shows a depth profile measured by using the time-of-flight secondary ion mass spectrometer in Example 4.

In reference to the Ni depth profiles of Examples, there is a place where the strength in the film is pumped up. Around here, the interface between the lower NiFe plating film and the upper NiFe plating film exists.

From the experiment results of Example 1 shown in FIG. 9A and Example 2 shown in FIG. 9B, it could be seen that, if the upper NiFe plating film is formed by plating to be thin, the NiS layer in the lower NiFe plating film moved into the upper NiFe plating film while the upper NiFe plating film formed by plating is grown, and the NiS layer existed in the upper NiFe plating film.

From the experiment results of Example 3 shown in FIG. 9C and Example 4 shown in FIG. 9D, it could be seen that, if the upper NiFe plating film is formed by plating to be thin, the strength of the NiS component was lowered in any depth regions, and the strength of the NiS component near the film surface is further lowered as compared with FIGS. 9A and 9B. That is, it could be seen that, if the upper NiFe plating film is formed by plating to be thin, the NiS layer in the lower NiFe plating film formed by plating with saccharin sodium added to the plating bath become extinct while the upper NiFe plating film formed by plating in the plating bath with no saccharin sodium added is grown.

[Experiment on Surface Roughness and Etching Rate of Plating Film of Second Embodiment]

A single-layer NiFe plating film of Comparative Example 1 was formed in the plating bath with no saccharin sodium dihydrate added, which was used in the above experiment. The plating time, the film thickness, and the Fe composition ratio are shown in Table 1.

A single-layer NiFe plating film of Comparative Example 2 was formed in the plating bath with saccharin sodium dihydrate added, which was used in the above experiment. The plating time, the film thickness, and the Fe composition ratio are shown in Table 1.

Similarly to the above experiment, a lower NiFe plating film was formed by plating for 10 minutes in a plating bath with saccharin sodium dihydrate added, and then an upper NiFe plating film was formed on the lower NiFe plating film by plating in a plating bath with no saccharin sodium dihydrate added (Examples 1 to 6). The plating time (10 seconds to 10 minutes) of the upper NiFe plating films in Examples are as shown in Table 1.

TABLE 1

| | | | | | | | Etching |
|---|---|---|---|---|---|---|---|
| | | | | Film | Fe | | Rate |
| | Presence/Absence | Plating Time | | Thickness | Composition | Ra | (nm/30 |
| | Saccharin | (min) | | (μm) | (wt %) | (Å) | min) |
| Comparative | No saccharin | 2 | | 0.3 | 68.4 | 10.5 | 90 |
| Example 1 | | 5 | | 0.7 | 66.9 | 15.8 | |
| | | 10 | | 1.4 | 65.6 | 34.2 | 80 |
| | | 20 | | 2.7 | 64.9 | 51 | 60 |
| Comparative | Saccharin Added | 2 | | 0.3 | 68.8 | 4.6 | 140 |
| Example 2 | | 5 | | 0.7 | 68.0 | 8 | |
| | | 10 | | 1.4 | 67.4 | 11.7 | 110 |
| | | 20 | | 2.8 | 66.4 | 17.8 | 100 |
| | | 10 | | 1.4 | 67.4 | 11.7 | |
| Example 1 | Saccharin Added | 10.17 | 10 Minutes + | 1.4 | 66.5 | 11.4 | |
| | → No Saccharin | | 10 Seconds | | | | |
| Example 2 | | 10.50 | 10 minutes + | 1.5 | 66.9 | 10.8 | |
| | | | 30 Seconds | | | | |
| Example 3 | | 11.00 | 10 Minutes + | 1.6 | 67.1 | 10.4 | |
| | | | 1 Minute | | | | |
| Example 4 | | 12.00 | 10 Minutes + | 1.7 | 66.9 | 12.5 | |
| | | | 2 Minute | | | | |
| Example 5 | | 15.00 | 10 Minutes + | 2.1 | 66.3 | 19.5 | 60 |
| | | | 5 Minute | | | | |
| Example 6 | | 20.00 | 10 Minutes + | 2.7 | 65.5 | 36.7 | 40 |
| | | | 10 Minute | | | | |

In Examples shown in Table 1, the film thickness is the total thickness of the lower NiFe plating film and the upper NiFe plating film. In addition, the Fe composition ratio is an average composition ratio in the lower NiFe plating film and the upper NiFe plating film.

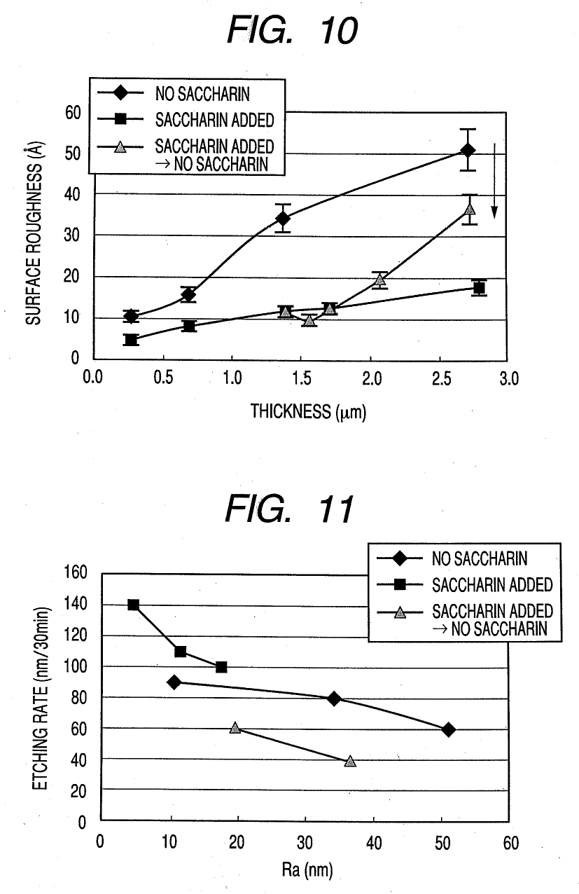

FIG. 10 is a graph showing surface roughness Ra of the film surfaces of the NiFe plating films of Comparative Example 1, Comparative Example 2, and Examples 1 to 6.

The surface roughness Ra of each of the NiFe plating films of Examples 1 to 6 may be equal to or larger than the surface roughness Ra of the NiFe plating film of Comparative Example 1, which is formed by plating in the plating bath with saccharin sodium dihydrate added, or may be smaller than the surface roughness Ra of the NiFe plating film of Comparative Example 2, which is formed by plating in the plating bath with no saccharin sodium dihydrate added. Specifically, it could be seen that the surface roughness Ra of the NiFe plating films of Examples might be 40 Å or less.

FIG. 11 is a graph showing etching rates of the film surfaces of the NiFe plating films of Comparative Example 1, Comparative Example 2, and Examples 1 to 6. The plating film was immersed in an etchant, for example, 5% diluted sulfuric acid, for 30 minutes and then the etching rate was measured.

Referring to FIG. 11, it could be seen that the NiFe plating films of Examples 1 to 6 have an etching rate smaller than the etching rates of the NiFe plating films of Comparative Example 1 and Comparative Example 2, and have excellent corrosion resistance. This may be because if an electrochemically noble upper NiFe plating film is superimposed on an electrochemically base lower NiFe plating film, the upper NiFe plating film absorbs electrons from the lower NiFe plating film, and then the electrochemically noble upper NiFe plating film becomes further stable.

### Depth Profile by Means of Time-of-Flight Secondary Ion Mass Spectrometry (TOF-SIMS); the Amount of Saccharin Sodium Dihydrate]

Next, a single-layer NiFe plating film was formed by plating in the following plating bath.

(Plating Bath Composition)

FeSO₄.7H₂O 25 (g/l)

NiSO₄.6H₂O 190 (g/l)

C₇H₄NO₃S.Na.2H₂O 0.05 g/l, 0.1 g/l, and 1.0 g/l

NaCl 25 g/l

C₁₂H₂₅NaO₄S 0.02 g/l

(Bath Condition)

Bath Temperature 30° C.

pH 2.7

Current Density (average) 6.4 mA/cm²

As described above, by using plating baths to which saccharin sodium dihydrate was added in different amounts of 0.05 g/l, 0.1 g/l, and 1.0 g/l, single-layer NiFe plating films were formed by plating. Then, the depth profiles of the single-layer NiFe plating films by means of the time-of-flight secondary ion mass spectrometry (TOF-SIMS) were obtained.

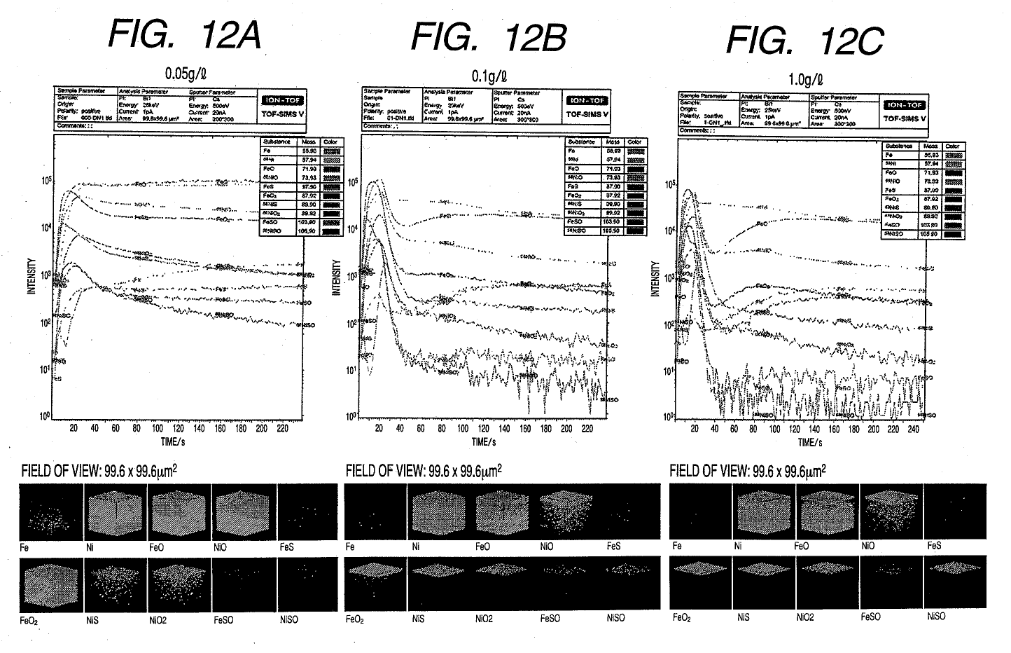

FIG. 12A is a three-dimensional schematic view showing the depth profile of a single-layer NiFe plating film formed by plating in a plating bath with 0.05 g/l of saccharin sodium dihydrate added and the states of individual components. FIG. 12B is a three-dimensional schematic view showing the depth profile of a single-layer NiFe plating film formed by plating in a plating bath with 0.1 g/l of saccharin sodium dihydrate added and the states of individual components. FIG. 12C is a three-dimensional schematic view showing the depth profile of a single-layer NiFe plating film formed by plating in a plating bath with 1.0 g/l of saccharin sodium dihydrate added and the states of individual components.

As shown in FIG. 12, it could be seen that, if the amount of saccharin sodium dihydrate in the plating bath was 0.05 g/l or more, the NiS layer could be formed in the plating film. The upper limit value of the amount of saccharin sodium dihydrate was 2 g/l which was used in the experiments of FIGS. 5A to 5C and FIGS. 6A to 6C. However, a smaller amount of saccharin sodium dihydrate is effective since the amount of an impurity, such as S (Sulfur), taken into the plating film can be reduced, and the film characteristics can be prevented from being deteriorated. As shown in FIG. 12A, when the amount of saccharin sodium dihydrate in the plating bath was 0.05 g/l, the NiS component near the film surface was reduced, as compared with a case where the amount of saccharin sodium dihydrate in the plating bath was 0.1 g/l or more. In addition, from the analysis results including the analysis result by the Auger electron spectroscopy (AES), it is considered that the NiS component exists thin over the substantially entire region, in addition to near the film surface. Therefore, more preferably, the amount of saccharin sodium dihydrate in the plating bath was set in a range of 0.1 g/l to 1.0 g/l.

[Sputter Ion for Time-of-Flight Secondary Ion Mass Spectrometry (TOF-SIMS)]

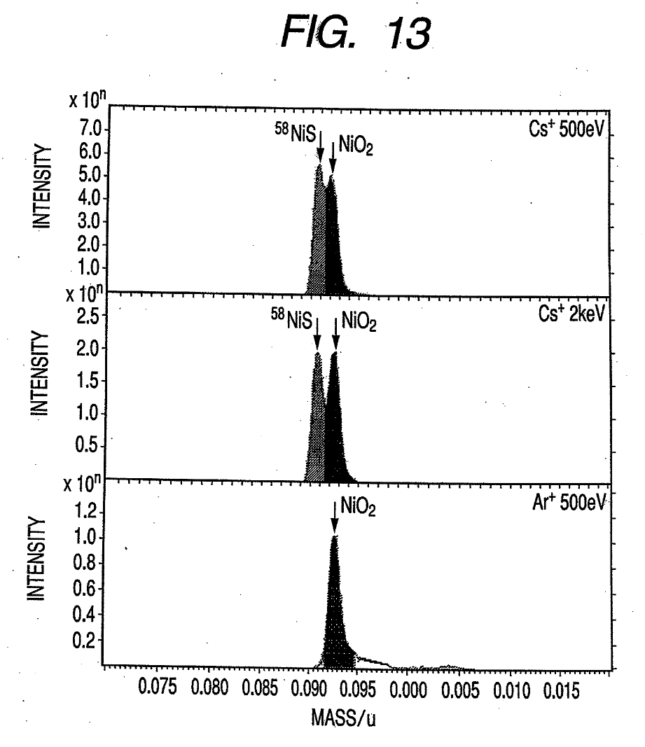

FIG. 13 shows an analysis result when sputter ions for the time-of-flight secondary ion mass spectrometry (TOF-SIMS) are Cs⁺ (500 eV), Cs⁺ (2 keV), and Ar⁺ (500 eV). As for a plating film to be analyzed, a single-layer NiFe plating film shown in FIG. 5A was used.

As shown in FIG. 13, if Ar⁺ was used as the sputter ions, the NiS component could not be analyzed. This may be because, if Ar⁺ is used as the sputter ions, Ni and S are separated and cannot be analyzed as the NiS component. Therefore, it could be seen that Cs⁺ was preferably used as the sputter ions.

Depth Profile by Means of Auger Electron Spectroscopy (AES)

FIG. 14 shows a Ni (cal.) depth profile by means of Auger electron spectroscopy (AES). As the Auger electron spectrometer, JAMP-7830F manufactured by JEOL Ltd. was used.

As for the measurement conditions, an electron beam of 5 keV, 10 nA was used and Ar⁺ (500 eV) was used as the sputter ions.

As for the measurement samples, NiFe plating films which are formed in the plating baths, used in FIGS. 5A and 12A to 12C, to which saccharin sodium dihydrate was added in different amounts, for example, 0.05 g/l, 0.1 g/l, 1.0 g/l, and 2.0 g/l, were used.

In FIG. 14, the vertical axis denotes the Ni (cal.) strength when the maximum value of the Fe peak strength is 1. The Ni (cal.) depth profile of FIG. 14 is reconstructed after the Ni and NiO components are separated from the Ni (orig.) depth profile, as shown in FIG. 15. Analysis was performed by using peak separation software (Spectra Investigator) manufactured by JEOL Ltd.

FIG. 16 shows a Ni difference depth profile which is obtained by subtracting the Ni (cal.) depth profile of a NiFe plating film formed by plating in a plating bath with no saccharin sodium dihydrate added from the Ni (cal.) depth profile of a NiFe plating film formed by plating in a plating bath with saccharin sodium dihydrate added.

As shown in FIG. 16, in the plating films with 0.1 g/l to 2.0 g/l of saccharin sodium dihydrate added, it could be seen that a peak was formed in the Ni difference depth profile near the film surface. From the analysis result by means of the time-of-flight secondary ion mass spectrometry (TOF-SIMS), the Ni difference near the film surface obtained from the analysis result by means of the Auger electron spectroscopy (AES) may be regarded as an inseparable component when peak separation of the NiS component or the NiSO component is performed. It could be seen that this coincided with the analysis result by means of the time-of-flight secondary ion mass spectrometry (TOF-SIMS). Meanwhile, in the plating film with 0.05 g/l of saccharin sodium dihydrate added, it could be seen that the peak in the Ni difference is not present near the film surface, and neither the NiS layer nor the NiSO layer is formed. Specifically, it is possible to determine that Ni is in an incomplete state. Therefore, as described with reference to FIG. 12, the amount of saccharin sodium dihydrate is preferably 0.1 g/l or more.

In the time-of-flight secondary ion mass spectrometry (TOF-SIMS), it can be confirmed that the NiS component or the NiSO component exists near the film surface, but it is difficult to quantitatively compare different samples.

Meanwhile, only in the Auger electron spectroscopy (AES), it is difficult to discriminate the state of Ni existing near the film surface (compound or element). However, unlike the time-of-flight secondary ion mass spectrometry (TOF-SIMS), it is possible to quantitatively compare the samples.

With the analysis results by means of the time-of-flight secondary ion mass spectrometry (TOF-SIMS) and the Auger electron spectroscopy (AES), in the depth profile of the Ni difference shown in FIG. 16, the Ni difference can be regarded as the amount of the existing NiS component or NiSO component, and the depth can be regarded as the thickness of the existing NiS component or NiSO component. Therefore, if a management value when the film is formed by plating is set on the basis of the analysis result of FIG. 16, the optimum amount of saccharin sodium or the optimum thickness of the plating film for allowing the NiS layer to be appropriately present can be adjusted.

It should be understood by those skilled in the art that various modifications, combinations, sub-combinations and alterations may occur depending on design requirements and other factors insofar as they are within the scope of the appended claims of the equivalents thereof.

1. A Ni-containing plating film, comprising:
a lower plating film; and
an upper plating film laminated on lower plating film,
wherein the lower plating film is formed by plating with no saccharin sodium added to a plating bath, and the upper plating film is formed by plating with saccharin sodium added to a plating bath, and
in the upper plating film, a NiS layer exists at a position below the film surface.

2. The Ni-containing plating film according to claim 1,
wherein at least a NiO₂ layer exists on the film surface, and at least a NiSO layer exists between the NiO₂ layer and the NiS layer.

3. The Ni-containing plating film according to claim 1,
wherein at least a Ni layer exists below the NiS layer.

4. The Ni-containing plating film according to claim 1,
wherein the NiS layer exists within 10 nm downward from the film surface.

5. A Ni-containing plating film, comprising:
a lower plating film; and
an upper plating film laminated on lower plating film,
wherein the lower plating film is formed by plating with saccharin sodium added to a plating bath, and the upper plating film is formed by plating with no saccharin sodium added to a plating bath, and
the surface roughness of the upper plating film is about 40 Å or less.

6. The Ni-containing plating film according to claim 5,
wherein, in the upper plating film, a NiS layer exists at a position below the film surface.

7. A Ni-containing plating film, comprising:
a lower plating film; and
an upper plating film laminated on lower plating film,
wherein the lower plating film is formed by plating with saccharin sodium added to a plating bath, and the upper plating film is formed by plating with no saccharin sodium added to a plating bath, and
in the upper plating film, a NiS layer exists at a position below the film surface.

8. The Ni-containing plating film according to claim 6,
wherein at least a NiO₂ layer exists on the film surface, and at least a NiSO layer exists between the NiO₂ layer and the NiS layer.

9. The Ni-containing plating film according to claim 6,
wherein at least a Ni layer exists below the NiS layer.

10. A Ni-containing plating film, comprising:
a lower plating film; and
an upper plating film laminated above the lower plating film,
wherein the lower plating film is formed by plating with saccharin sodium added to a plating bath, and the upper plating film is formed by plating with no saccharin sodium added to a plating bath, and
an intermediate film is provided between the lower plating film and the upper plating film so as not to move a NiS layer toward the upper plating film.

11. The Ni-containing plating film according to claim 1,
wherein the existence of the NiS layer, the NiO₂ layer, and the NiSO layer is analyzed by means of time-of-flight secondary ion mass spectrometry (TOF-SIMS).

12. The Ni-containing plating film according to claim 11,
wherein the existence is analyzed by means of Auger electron spectroscopy (AES).

13. The Ni-containing plating film according to claim 1,
wherein the lower plating film and the upper plating film are formed of a NiFe alloy.

14. A method of manufacturing a Ni-containing plating film, the method comprising the steps of:
forming a lower plating film by plating; and
forming an upper plating film by plating to be laminated on the lower plating film,
wherein the lower plating film is formed by plating with no saccharin sodium added to a plating bath containing Ni ions, and the upper plating film is formed by plating with about 0.05 g/l to about 2.0 g/l of saccharin sodium dihydrate added to a plating bath containing Ni ions, and
in the upper plating film, a NiS layer is formed at a position below the film surface.

15. The method according to claim 14,
wherein the upper plating film is formed by plating to have such a small thickness that the NiS layer becomes a lowermost layer in the upper plating film.

16. A method of manufacturing a Ni-containing plating film, the method comprising the steps of:
forming a lower plating film by plating; and
forming an upper plating film by plating to be laminated on the lower plating film,
wherein the lower plating film is formed by plating with about 0.05 g/l to about 2.0 g/l of saccharin sodium dihydrate added to a plating path containing Ni ions, and the upper plating film is formed by plating with no saccharin sodium added to the plating path containing Ni ions.

17. The method according to claim 16,
wherein the upper plating film is formed by plating to have such a thickness that a NiS layer in the lower plating film becomes extinct with plating growth of the upper plating film.

18. The method according to claim 16,
wherein the upper plating film is formed by plating to have such a thickness that a NiS layer in the lower plating film moves into the upper plating film with plating growth of the upper plating film, but does not reach the outmost surface of the upper plating film.

19. A method of manufacturing a Ni-containing plating film, the method comprising the steps of:
forming a lower plating film by plating; and
forming an upper plating film by plating to be laminated above the lower plating film,
wherein the lower plating film is formed by plating with about 0.05 g/l to about 2.0 g/l of saccharin sodium dihydrate added to a plating path containing Ni ions, an intermediate film is formed on the lower plating film so as not to move a NiS layer formed in the lower plating film toward the upper plating film, and the upper plating film is formed by plating on the intermediate film with no saccharin sodium added to the plating bath.

20. The method according to claim 14,
wherein the amount of saccharin sodium dihydrate in the plating bath is in a range of about 0.1 g/l to about 1.0 g/l.

21. The method according to claim 14,
wherein the thickness of the upper plating film or the intermediate film, or the amount of saccharin sodium is adjusted on the basis of an analysis result by time-of-flight secondary ion mass spectrometry (TOF-SIMS).

22. The method according to claim 14,
wherein the thickness of the upper plating film of the intermediate film, or the amount of saccharin sodium is adjusted on the basis of an analysis result by Auger electron spectroscopy (AES).

23. The method according to claim 14,
wherein the lower plating film and the upper plating film are formed of a NiFe alloy by plating.
